(19) United States
(12) Patent Application Publication
(10) Pub. No.: US 2010/0140546 A1
(43) Pub. Date: Jun. 10, 2010

(54) Method for the Continuous Mixing of Polymer Particles

(75) Inventors: Holger Barthel, Schwetzingen (DE); Matthias Weismantel, Jossgrund-Oberndorf (DE); Karin Ax, Worms (DE); Wolfgang Kanther, Dannstadt-Schauernheim (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: BASF SE, Ludwigshafen (DE)

(21) Appl. No.: 12/093,710

(22) PCT Filed: Nov. 30, 2006
(86) PCT No.: PCT/EP2006/069103

§ 371 Date: May 14, 2008

(30) Foreign Application Priority Data
Dec. 7, 2005 (DE) 10 2005 058 631.7
Feb. 10, 2006 (DE) 10 2006 006 539.5

(51) Int. Cl. B01J 20/26

(52) U.S. Cl. 252/194

(57) ABSTRACT

In a process for continuous mixing of water-absorbing polymeric particles with liquids or other particles while the polymeric particles move in the product stream direction under their own weight, at least a portion of the material undergoing mixing acquires, through the rotational movement of at least one mixing tool secured to a rotating shaft, a momentum opposite the product stream direction.

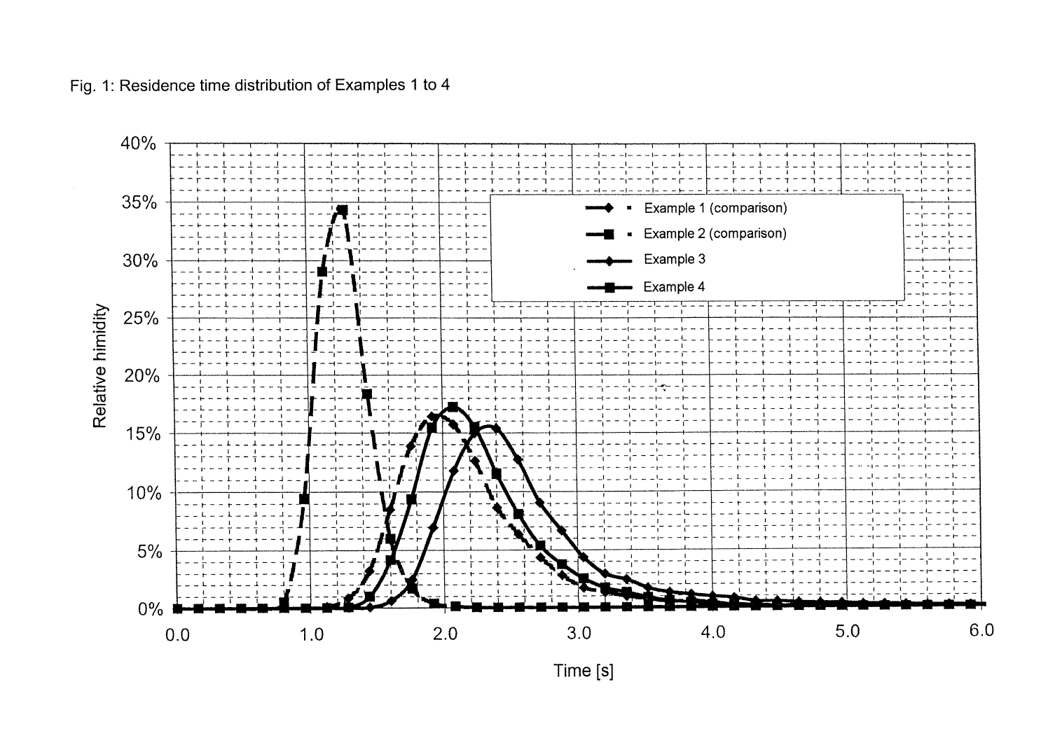

The present invention relates to a process for continuous mixing of water-absorbing polymeric particles with liquids or other particles while the polymeric particles move in the product stream direction under their own weight and at least a portion of the material undergoing mixing acquiring, through the rotational movement of at least one mixing tool secured to a rotating shaft, a momentum opposite the product stream direction.

Water-absorbing polymers are in particular polymers of (co)polymerized hydrophilic monomers, graft (co)polymers of one or more hydrophilic monomers on a suitable grafting base, crosslinked ethers of cellulose or of starch, crosslinked carboxymethylcellulose, partially crosslinked polyalkylene oxide or natural products swellable in aqueous fluids, such as guar derivatives for example. Such polymers are used as products capable of absorbing aqueous solutions to produce diapers, tampons, sanitary napkins and other hygiene articles, but also as water-retaining agents in market gardening.

The production of water-absorbing polymers is described for example in the monograph “Modern Superabsorbent Polymer Technology”, F. L. Buchholz and A. T. Graham, Wiley-VCH, 1998, pages 69 to 117.

Water-absorbing polymers typically have a Centrifuge Retention Capacity in the range from 25 to 60 g/g, preferably of at least 30 g/g, more preferably of at least 32 g/g, even more preferably of at least 34 g/g and most preferably of at least 35 g/g. Centrifuge Retention Capacity (CRC) is determined by EDANA (European Disposables and Nonwovens Association) recommended test method No. 441.2-02 “Centrifuge retention capacity”.

To improve their performance characteristics, for example permeability, water-absorbing polymeric particles are generally postcrosslinked. This postcrosslinking can be carried out in the aqueous gel phase. Preferably, however, ground and screened particles of the base polymer are surface coated with a postcrosslinker, dried and thermally postcrosslinked. Useful crosslinkers for this purpose include compounds comprising at least two groups capable of forming covalent bonds with the carboxylate groups of the hydrophilic polymer or capable of crosslinking together at least two carboxyl groups or other functional groups of at least two different polymeric chains of the base polymer.

DE-A 35 23 617 discloses a process for postcrosslinking water-absorbing polymeric particles wherein a polyol is metered in a, preferably aqueous, solvent.

WO 04/037900 discloses a process for mixing water-absorbing polymeric particles with aqueous solutions wherein the formation of agglomerates during mixing is avoided by virtue of a high kinetic energy on the part of the polymeric particles.

WO 05/080479 describes a process for postcrosslinking water-absorbing polymeric particles wherein two separate solutions are metered. High speed mixers are preferably used according to the patent application.

It is an object of the present invention to provide an improved process for mixing water-absorbing polymeric particles with aqueous solutions.

We have found that this object is achieved by a process for continuous mixing of water-absorbing polymeric particles with liquids or other particles while the polymeric particles move in the product stream direction under their own weight, wherein at least a portion of the material undergoing mixing acquires, through the rotational movement of at least one mixing tool secured to a rotating shaft, a momentum opposite the product stream direction.

Liquids are materials that are liquid at 23° C. or solid materials liquefied by temperature elevation. Useful liquid materials include for example liquid postcrosslinkers or postcrosslinker solutions, which are applied to water-absorbing polymeric particles.

Other particles are particulate solids other than the water-absorbing polymeric particles. Pyrogenic silica is an example of a useful particulate solid.

The product stream direction is the direction of transport of the polymeric particles through the mixer; that is, the transportation path through the mixer from the mixer's inlet to its outlet.

The polymeric particles move downwardly through the mixer. As a result, the polymeric particles are, under their own weight, accelerated in the product stream direction by the force of gravity.

The front edge of the mixing tool in the direction of rotation is below its rear edge; that is, the mixing tool has a positive angle of pitch and transports the polymeric particles in the direction opposite the product stream direction.

Consequently, a negative angle of pitch means that the mixing tool will transport the polymeric particles in the product stream direction.

The liquids or other particles are customarily metered from above into the mixer, preferably by spraying through suitable nozzles, more preferably by means of at least one two material nozzle and most preferably by means of at least four two material nozzles.

When a plurality of nozzles are used, the liquid and the other particles to be spray dispensed can be better distributed. Advantageously, a plurality of nozzles, for example two, can be supplied through a conjoint supply line.

Using mixers in which the material being mixed free-falls minimizes the risk of agglomeration prevalent when mixing water-absorbing polymeric particles with aqueous fluids. Hitherto mixing has been achieved via a sufficiently high circumferential speed for the tips of the mixing tools. The mixing tools used had a negative angle of pitch and the rotation of the mixing tools imparted to the water-absorbing polymeric particles a momentum in and transverse to the product stream direction.

The present invention rests on the discovery that reversing the hitherto customary direction of transport of the mixing tools will give even at moderate circumferential speeds a residence time distribution that hitherto required very much higher circumferential speeds.

Useful mixing tools include for example blades or paddles.

The number of mixing tools is preferably in the range from 2 to 64, more preferably in the range from 4 to 32 and most preferably in the range from 8 to 16. It is possible for 2, 4 or 8 mixing tools at a time to be situated in the conjoint plane.

The mixing tools may project radially sideways from the shaft; that is the angle between the shaft's axis and the connection line from the point of securement of the mixing tool to the shaft to the tip of the mixing tool is about 90°.

The mixing tools may also project in V-shaped pairs sideways from the shaft, in which case the angle enclosed by the paired arrangement of the mixing tools is preferably in the range from 30 to 120°, more preferably in the range from 45 to 105° and most preferably in the range from 60 to 90°.

It is also possible to utilize both arrangements of mixing tools in one mixer.

The shaft is preferably mounted at one or both of the ends.

The circumferential speed of the mixing tools is typically in the range from 3 to 20 m/s, preferably in the range from 4 to 18 m/s, more preferably in the range from 6 to 15 m/s and most preferably in the range from 8 to 12 m/s.

The angle of inclination of the product stream direction with regard to the vertical is typically less than 45°, preferably less than 30°, more preferably less than 15° and most preferably less than 5°. Preferably, the polymeric particles fall perpendicularly downward through the mixer; that is, product stream direction is vertical.

The angle between product stream direction and shaft axis is preferably less than 10°, more preferably less than 5° and most preferably less than 1°. Preferably, product stream direction and shaft axis are identical; that is, the angle between the two is 0°.

The pitch angle of the at least one mixing tool is typically in the range form greater than 0 to 30°, preferably in the range from 5 to 25°, more preferably in the range from 10 to 20° and most preferably in the range from 15 to 18°.

The mixer preferably has a cylindrical wall. The diameter of the cylinder is preferably in the range from 90 to 500 mm, more preferably in the range from 120 to 400 mm and most preferably in the range from 150 to 350 mm.

The ratio of the diameter of the circumferential path of the extreme tip of the mixing tool to the largest possible diameter of this circumferential path is preferably at least 0.6, more preferably at least 0.7 and most preferably at least 0.8. The largest possible diameter of the circumferential path is the theoretical diameter of the circumferential path at which the tip of the mixing tool would just touch the mixer wall nearest the shaft axis. In the case of a cylindrical mixer having a centric shaft, this largest possible diameter of the circumferential path is equal to the internal diameter of the mixer.

The throughput of polymeric particles per m² of cross-sectional area of the mixer is preferably in the range from 10 to 250 t/h, more preferably in the range from 25 to 150 t/h and most preferably in the range from 50 to 100 t/h (t=metric ton).

In one preferred embodiment of the present invention, at least a portion of the material undergoing mixing acquires, through the rotational movement of at least one additional mixing tool secured to a rotating shaft, a momentum in the product stream direction.

Preferably, the mixing tools through which at least a portion of the material undergoing mixing acquires a momentum opposite the product stream direction are disposed in terms of the product stream direction upstream of the mixing tools through which at least a portion of the material undergoing mixing acquires a momentum in the product stream direction.

More preferably, all mixer tools are situated on a common shaft.

The pitch angle of the additional mixing tools is typically in the range from less than 0 to −30°, preferably in the range from −2 to −25°, more preferably in the range from −5 to −15° and most preferably in the range from −8 to −12°.

For instance, the mixing tools may be disposed in three planes, so that the mixing tools of the upper mixing plane have a positive pitch angle and the mixing tools of the two lower mixing tool planes have a negative pitch angle.

This combination of mixing tools of positive and negative pitch angle minimizes or prevents gas flows opposite the product stream direction.

The process of the present invention is preferably utilized for postcrosslinking water-absorbing polymeric particles. Preferably, at least one postcrosslinker is used as an aqueous solution for postcrosslinking. The aqueous solution may comprise organic compounds, such as isopropanol, propylene glycol or 1,3-propanediol, as a cosolvent.

The process of the present invention is further useful for admixing further liquids, such as water and aqueous solutions, and also other particles, such as pyrogenic silica.

A particularly preferred embodiment utilizes a vertical cylindrical mixer having a vertical shaft axis. The mixing tools are arranged in two or three rows one above the other, each row comprising four pairs of mixing tools in a V-shaped arrangement having a positive angle of pitch.

The water-absorbing polymeric particles usable in the process of the present invention can be produced by addition polymerization of a monomer solution comprising
a) at least one ethylenically unsaturated acid-functional monomer,
b) at least one crosslinker,
c) if appropriate one or more ethylenically and/or allylically unsaturated monomers copolymerizable with a), and
d) if appropriate one or more water-soluble polymers onto which the monomers a), b) and if appropriate c) can be at least partly grafted,
   the polymer obtained being dried and classified.

Suitable monomers a) are for example ethylenically unsaturated carboxylic acids, such as acrylic acid, methacrylic acid, maleic acid, fumaric acid and itaconic acid. Acrylic acid and methacrylic acid are particularly preferred monomers. Acrylic acid is most preferable.

The proportion of the total amount of monomers a) which is attributable to acrylic acid and/or its salts is preferably at least 50 mol %, more preferably at least 90 mol % and most preferably at least 95 mol %.

The monomers a) and especially acrylic acid comprise preferably up to 0.025% by weight of a hydroquinone half ether. Preferred hydroquinone half ethers are hydroquinone monomethyl ether (MEHQ) and/or tocopherols.

Tocopherol refers to compounds of the following formula:

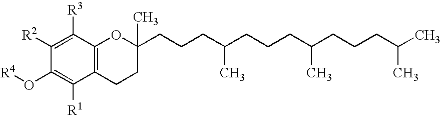

where R¹ is hydrogen or methyl, R² is hydrogen or methyl, R³ is hydrogen or methyl and R⁴ is hydrogen or an acid radical of 1 to 20 carbon atoms.

Preferred R⁴ radicals are acetyl, ascorbyl, succinyl, nicotinyl and other physiologically tolerable carboxylic acids. The carboxylic acids can be mono-, di- or tricarboxylic acids.

Preference is given to alpha-tocopherol where R¹═R²=R³=methyl, especially racemic alpha-tocopherol. R⁴ is more preferably hydrogen or acetyl. RRR-alpha-Tocopherol is preferred in particular.

The monomer solution comprises preferably not more than 130 weight ppm, more preferably not more than 70 weight ppm, preferably not less than 10 weight ppm, more preferably not less than 30 weight ppm and especially about 50 weight ppm of hydroquinone half ether, all based on acrylic acid, with acrylic acid salts being arithmetically counted as acrylic acid. For example, the monomer solution can be produced using an acrylic acid having an appropriate hydroquinone half ether content.

The water-absorbing polymers are in a crosslinked state, i.e., the addition polymerization is carried out in the presence of compounds having two or more polymerizable groups which can be free-radically interpolymerized into the polymer network. Useful crosslinkers b) include for example ethylene glycol dimethacrylate, diethylene glycol diacrylate, allyl methacrylate, trimethylolpropane triacrylate, triallylamine, tetraallyloxyethane as described in EP-A-0 530 438, di- and triacrylates as described in EP-A-0 547 847, EP-A-0 559 476, EP-A-0 632 068, WO 93/21237, WO 03/104299, WO 03/104300, WO 03/104301 and DE-A-10331450, mixed acrylates which, as well as acrylate groups, comprise further ethylenically unsaturated groups, as described in DE-A-103 31 456 and DE-A-103 55 401, or crosslinker mixtures as described for example in DE-A 195 43 368, DE-A 196 46 484, WO 90/15830 and WO 02/32962.

Useful crosslinkers b) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described for example in EP-A-0 343 427. Useful crosslinkers b) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. The process of the present invention utilizes di(meth)acrylates of polyethylene glycols, the polyethylene glycol used having a molecular weight between 300 and 1000.

However, particularly advantageous crosslinkers b) are di- and triacrylates of 3- to 20-tuply ethoxylated glycerol, of 3- to 20-tuply ethoxylated trimethylolpropane, of 3- to 20-tuply ethoxylated trimethylolethane, especially di- and triacrylates of 2- to 6-tuply ethoxylated glycerol or of 2- to 6-tuply ethoxylated trimethylolpropane, of 3-tuply propoxylated glycerol, of 3-tuply propoxylated trimethylolpropane, and also of 3-tuply mixedly ethoxylated or propoxylated glycerol, of 3-tuply mixedly ethoxylated or propoxylated trimethylolpropane, of 15-tuply ethoxylated glycerol, of 15-tuply ethoxylated trimethylolpropane, of at least 40-tuply ethoxylated glycerol, of at least 40-tuply ethoxylated trimethylolethane and also of at least 40-tuply ethoxylated trimethylolpropane.

Very particularly preferred for use as crosslinkers b) are diacrylated, dimethacrylated, triacrylated or trimethacrylated multiply ethoxylated and/or propoxylated glycerols as described for example in DE-A-103 19 462. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 weight ppm) in the water-absorbing polymer and the aqueous extracts of water-absorbing polymers produced therewith have an almost unchanged surface tension compared with water at the same temperature (typically not less than 0.068 N/m).

The amount of crosslinker b) is preferably from 0.001 to 10 mol %, more preferably from 0.01 to 5 mol % and most preferably from 0.1 to 2 mol %, all based on monomer a).

Examples of ethylenically unsaturated monomers c) which are copolymerizable with the monomers a) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers d) include polyvinyl alcohol, polyvinylpyrrolidone, starch, starch derivatives, polyglycols or polyacrylic acids, preferably polyvinyl alcohol and starch.

The preparation of a suitable polymer and also further useful hydrophilic ethylenically unsaturated monomers a) are described in DE-A-199 41 423, EP-A-0 686 650, WO 01/45758 and WO 03/104300.

Kneading reactors or belt reactors are suitable reactors. In a kneader, the polymer gel which is produced in the course of the polymerization of an aqueous monomer solution is for example continuously comminuted by contrarotatory stirring shafts, as described in WO 01/38402. The polymerization on a belt is described for example in DE-A 38 25 366 and U.S. Pat. No. 6,241,928. The polymerization in a belt reactor produces a polymer gel which has to be comminuted in a further process step, for example in a meat grinder, extruder or kneader.

Advantageously, the hydrogel after leaving the polymerization reactor is stored at a comparatively high temperature, preferably at least 50° C., more preferably at least 70° C. and most preferably at least 80° C. and also preferably less than 100° C., for example in insulated containers. Storage, typically for 2 to 12 hours, further increases monomer conversion.

The acid groups of the hydrogels obtained are typically in a partially neutralized state, the extent of neutralization preferably being in the range from 25 to 95 mol %, more preferably in the range from 50 to 80 mol % and even more preferably in the range from 60 to 75 mol %, for which the customary neutralizing agents can be used, for example alkali metal hydroxides, alkali metal oxides, alkali metal carbonates or alkali metal bicarbonates and also mixtures thereof. Ammonium salts can also be used instead of alkali metal salts. Sodium and potassium are particularly preferred as alkali metals, but most preference is given to sodium hydroxide, sodium carbonate or sodium bicarbonate and also mixtures thereof.

Neutralization is preferably carried out at the monomer stage. This is customarily accomplished by admixing the neutralizing agent as an aqueous solution, as a melt or else preferably as a solid material. For example, sodium hydroxide having a water fraction of distinctly below 50% by weight can be present as a waxy mass having a melting point above 23° C. In this case, metering as piece goods or melt at elevated temperature is possible.

Neutralization can also be carried out after polymerization, at the hydrogel stage. But it is also possible to neutralize up to 40 mol %, preferably from 10 to 30 mol % and more preferably from 15 to 25 mol % of the acid groups before polymerization by adding a portion of the neutralizing agent to the monomer solution and setting the desired final degree of neutralization only after polymerization, at the hydrogel stage. When the hydrogel is neutralized at least partly after polymerization, the hydrogel is preferably mechanically comminuted, for example by means of a meat grinder, in which case the neutralizing agent can be sprayed, sprinkled or poured on and then carefully mixed in. To this end, the gel mass obtained can be repeatedly grindered for homogenization.

The hydrogel is then preferably dried with a belt dryer until the residual moisture content is preferably below 15% by weight and especially below 10% by weight, the water content being determined by EDANA (European Disposables and Nonwovens Association) recommended test method No. 430.2-02 “Moisture content”. Selectively, drying can also be carried out using a fluidized bed dryer or a heated plowshare mixer. To obtain particularly white products, it is advantageous to dry this gel by ensuring rapid removal of the evaporating water. To this end, the dryer temperature must be optimized, the air feed and removal has to be policed, and at all times sufficient venting must be ensured. Drying is naturally all the more simple—and the product all the more white—when the solids content of the gel is as high as possible. The solids content of the gel prior to drying is therefore preferably between 30% and 80% by weight. It is particularly advantageous to vent the dryer with nitrogen or some other non-oxidizing inert gas. Selectively, however, simply just the partial pressure of the oxygen can be lowered during drying to prevent oxidative yellowing processes. But in general adequate venting and removal of the water vapor will likewise still lead to an acceptable product. A very short drying time is generally advantageous with regard to color and product quality.

A further important function of drying the gel is the ongoing reduction in the residual monomer content of the superabsorbent. This is because any residual initiator will decompose during drying, leading to any residual monomers becoming interpolymerized. In addition, the evaporating amounts of water will entrain any free water-vapor-volatile monomers still present, such as acrylic acid for example, and thus likewise lower the residual monomer content of the superabsorbent.

The dried hydrogel is then ground and classified, useful grinding apparatus typically including single or multiple stage roll mills, preferably two or three stage roll mills, pin mills, hammer mills or swing mills.

The polymer obtained may subsequently be postcrosslinked. Useful postcrosslinkers are compounds comprising two or more groups capable of forming covalent bonds with the carboxylate groups of the polymers. Useful compounds are for example alkoxysilyl compounds, polyaziridines, polyamines, polyamidoamines, di- or polyglycidyl compounds as described in EP-A-0 083 022, EP-A 0 543 303 and EP-A 0 937 736, polyhydric alcohols as described in DE-C 33 14 019, DE-C 35 23 617 and EP-A 450 922, or β-hydroxyalkylamides as described in DE-A 102 04 938 and U.S. Pat. No. 6,239,230. It is also possible to use compounds of mixed functionality, such as glycidol, 3-ethyl-3-oxetanemethanol (trimethylolpropaneoxetane), as described in EP-A 1 199 327, aminoethanol, diethanolamine, triethanolamine or compounds which develop a further functionality after the first reaction, such as ethylene oxide, propylene oxide, isobutylene oxide, aziridine, azetidine or oxetane.

Useful postcrosslinkers are further said to include by DE-A 40 20 780 cyclic carbonates, by DE-A 198 07 502 2-oxazolidone and its derivatives, such as N-(2-hydroxyethyl)-2-oxazolidone, by DE-A 198 07 992 bis- and poly-2-oxazolidinones, by DE-A 198 54 573 2-oxotetrahydro-1,3-oxazine and its derivatives, by DE-A 198 54 574 N-acyl-2-oxazolidones, by DE-A 102 04 937 cyclic ureas, by DE-A-103 34 584 bicyclic amide acetals, by EP-A 1 199 327 oxetanes and cyclic ureas and by WO 03/031482 morpholine-2,3-dione and its derivatives.

Preferred postcrosslinkers are oxazolidone and its derivatives, in particular N-(2-hydroxyethyl)-2-oxazolidone.

The amount of postcrosslinker is preferably in the range from 0.001% to 5% by weight, more preferably in the range from 0.01% to 2.5% by weight and most preferably in the range from 0.1% to 1% by weight, all based on the polymer.

Postcrosslinking is customarily carried out by spraying the hydrogel or the dry polymeric particles with a solution, preferably an aqueous solution, of the postcrosslinker. Spraying is followed by thermal drying, and the postcrosslinking reaction can take place not only before but also during drying.

The postcrosslinker is advantageously mixed with the polymer by the process of the present invention and subsequently thermally dried.

Contact dryers are preferable, shovel dryers more preferable and disk dryers most preferable as apparatus in which thermal drying is carried out. Suitable dryers include for example Bepex® dryers and Nara® dryers. Fluidized bed dryers can be used as well.

Drying can take place in the mixer itself, by heating the shell or blowing warm air into it. It is similarly possible to use a downstream dryer, for example a tray dryer, a rotary tube oven or a heatable screw. But it is also possible for example to utilize an azeotropic distillation as a drying process.

Preferred drying temperatures range from 50 to 250° C., preferably from 50 to 200° C., and more preferably from 50 to 150° C. The preferred residence time at this temperature in the reaction mixer or dryer is below 30 minutes and more preferably below 10 minutes.

### EXAMPLES

The examples simulate the mixing behavior in a Schugi® Flexomix Type 335 (Hosokawa Micron Group, Japan).

The mixing operation was computed by a discrete element method (DEM). The trajectories of each individual particle present in the geometry were monitored simultaneously under the action of external forces. The forces contemplated here are the force of gravity and also contact forces arising on contact between two particles or between particles and stationary walls (shell geometry) or moving walls (mixing tools). Slip friction only is assumed to occur. A linear spring-damper model was used for all particle contacts. Interaction with a gas flow was not considered.

The particles simulated had a diameter of 5 mm and a solid density of 1640 kg/m³. The wall friction angle and the internal friction angle of the particles is 42°. The spring constant is 400 N/m and the particles' effective coefficient of restitution is set at 0.5. The mass flow of the particles is 8 t/h. The time for each particle is measured between the entry into the geometry and the exit from the geometry. A steady state becomes established after 2 to 5 seconds, depending on the method of operation. The residence time distribution was only determined once a steady state had become established.

### Example 1 (Comparative Example)

The residence time distribution was computed for a speed of 1800 rpm. The mixing tools had a negative pitch angle of 18°; that is, the particles were given, by the rotating mixing tools, a momentum in the product stream direction.

TABLE 1
1800 rpm, negative angle of pitch

| Time [s] | Number | Total | Frequency [%] | Cumulative [%] |
|---|---|---|---|---|
| 0.96 | 2 | 2 | 0.02 | 0.02 |
| 1.12 | 10 | 12 | 0.11 | 0.14 |
| 1.28 | 76 | 88 | 0.86 | 1.00 |
| 1.44 | 284 | 372 | 3.21 | 4.21 |
| 1.60 | 753 | 1125 | 8.51 | 12.72 |
| 1.76 | 1227 | 2352 | 13.87 | 26.59 |
| 1.92 | 1453 | 3805 | 16.43 | 43.02 |
| 2.08 | 1391 | 5196 | 15.73 | 58.75 |
| 2.24 | 1113 | 6309 | 12.58 | 71.34 |
| 2.40 | 766 | 7075 | 8.66 | 80.00 |
| 2.56 | 563 | 7638 | 6.37 | 86.36 |
| 2.72 | 385 | 8023 | 4.35 | 90.72 |
| 2.88 | 249 | 8272 | 2.82 | 93.53 |
| 3.04 | 153 | 8425 | 1.73 | 95.26 |
| 3.20 | 118 | 8543 | 1.33 | 96.60 |
| 3.36 | 86 | 8629 | 0.97 | 97.57 |
| 3.52 | 66 | 8695 | 0.75 | 98.32 |
| 3.68 | 42 | 8737 | 0.47 | 98.79 |
| 3.84 | 52 | 8789 | 0.59 | 99.38 |
| 4.00 | 37 | 8826 | 0.42 | 99.80 |
| 4.16 | 15 | 8841 | 0.17 | 99.97 |
| 4.32 | 3 | 8844 | 0.03 | 100.00 |

### Example 2 (Comparative Example)

Example 1 was repeated at 700 rpm.

TABLE 2
700 rpm, negative angle of pitch

| Time [s] | Number | Total | Frequency [%] | Cumulative [%] |
|---|---|---|---|---|
| 0.64 | 1 | 1 | 0.00 | 0.00 |
| 0.80 | 130 | 131 | 0.56 | 0.56 |
| 0.96 | 2206 | 2337 | 9.44 | 10.00 |
| 1.12 | 6787 | 9124 | 29.03 | 39.02 |
| 1.28 | 8031 | 17155 | 34.35 | 73.37 |
| 1.44 | 4296 | 21451 | 18.37 | 91.75 |
| 1.60 | 1404 | 22855 | 6.00 | 97.75 |
| 1.76 | 394 | 23249 | 1.69 | 99.44 |
| 1.92 | 89 | 23338 | 0.38 | 99.82 |
| 2.08 | 32 | 23370 | 0.14 | 99.95 |
| 2.24 | 7 | 23377 | 0.03 | 99.98 |
| 2.40 | 2 | 23379 | 0.01 | 99.99 |
| 2.56 | 2 | 23381 | 0.01 | 100.00 |

### Example 3

Example 2 was repeated with the mixing tools having a positive pitch angle of 18°; that is, the particles were given, by the rotating mixing tools, a momentum opposite the product stream direction.

TABLE 3
700 rpm, positive angle of pitch

| Time [s] | Number | Total | Frequency [%] | Cumulative [%] |
|---|---|---|---|---|
| 1.12 | 1 | 1 | 0.00 | 0.00 |
| 1.28 | 4 | 5 | 0.01 | 0.02 |
| 1.44 | 20 | 25 | 0.07 | 0.09 |
| 1.60 | 167 | 192 | 0.61 | 0.70 |
| 1.76 | 670 | 862 | 2.46 | 3.16 |
| 1.92 | 1897 | 2759 | 6.96 | 10.13 |
| 2.08 | 3207 | 5966 | 11.77 | 21.90 |
| 2.24 | 4081 | 10047 | 14.98 | 36.88 |
| 2.40 | 4195 | 14242 | 15.40 | 52.28 |
| 2.56 | 3460 | 17702 | 12.70 | 64.99 |
| 2.72 | 2475 | 20177 | 9.09 | 74.07 |
| 2.88 | 1824 | 22001 | 6.70 | 80.77 |
| 3.04 | 1195 | 23196 | 4.39 | 85.15 |
| 3.20 | 796 | 23992 | 2.92 | 88.08 |
| 3.36 | 667 | 24659 | 2.45 | 90.52 |
| 3.52 | 463 | 25122 | 1.70 | 92.22 |
| 3.68 | 363 | 25485 | 1.33 | 93.56 |
| 3.84 | 306 | 25791 | 1.12 | 94.68 |
| 4.00 | 260 | 26051 | 0.95 | 95.64 |
| 4.16 | 221 | 26272 | 0.81 | 96.45 |
| 4.32 | 139 | 26411 | 0.51 | 96.96 |
| 4.48 | 136 | 26547 | 0.50 | 97.46 |
| 4.64 | 110 | 26657 | 0.40 | 97.86 |
| 4.80 | 88 | 26745 | 0.32 | 98.18 |
| 4.96 | 90 | 26835 | 0.33 | 98.51 |
| 5.12 | 61 | 26896 | 0.22 | 98.74 |
| 5.28 | 59 | 26955 | 0.22 | 98.95 |
| 5.44 | 47 | 27002 | 0.17 | 99.13 |
| 5.60 | 38 | 27040 | 0.14 | 99.27 |
| 5.76 | 34 | 27074 | 0.12 | 99.39 |
| 5.92 | 31 | 27105 | 0.11 | 99.50 |
| 6.08 | 20 | 27125 | 0.07 | 99.58 |
| 6.24 | 26 | 27151 | 0.10 | 99.67 |
| 6.40 | 13 | 27164 | 0.05 | 99.72 |
| 6.56 | 13 | 27177 | 0.05 | 99.77 |
| 6.72 | 18 | 27195 | 0.07 | 99.83 |
| 6.88 | 10 | 27205 | 0.04 | 99.87 |
| 7.04 | 9 | 27214 | 0.03 | 99.90 |
| 7.20 | 7 | 27221 | 0.03 | 99.93 |
| 7.36 | 2 | 27223 | 0.01 | 99.94 |
| 7.52 | 3 | 27226 | 0.01 | 99.95 |
| 7.68 | 4 | 27230 | 0.01 | 99.96 |
| 7.84 | 2 | 27232 | 0.01 | 99.97 |
| 8.00 | 8 | 27240 | 0.03 | 100.00 |

### Example 4

Example 3 was repeated at 575 rpm.

TABLE 4
575 rpm, positive angle of pitch

| Time [s] | Number | Total | Frequency [%] | Cumulative [%] |
|---|---|---|---|---|
| 0.96 | 1 | 1 | 0.00 | 0.00 |
| 1.12 | 3 | 4 | 0.01 | 0.02 |
| 1.28 | 17 | 21 | 0.07 | 0.09 |
| 1.44 | 230 | 251 | 1.00 | 1.09 |
| 1.60 | 965 | 1216 | 4.18 | 5.27 |
| 1.76 | 2168 | 3384 | 9.39 | 14.65 |
| 1.92 | 3572 | 6956 | 15.47 | 30.12 |
| 2.08 | 3984 | 10940 | 17.25 | 47.38 |
| 2.24 | 3581 | 14521 | 15.51 | 62.88 |
| 2.40 | 2661 | 17182 | 11.52 | 74.41 |
| 2.56 | 1872 | 19054 | 8.11 | 82.51 |
| 2.72 | 1239 | 20293 | 5.37 | 87.88 |
| 2.88 | 868 | 21161 | 3.76 | 91.64 |
| 3.04 | 583 | 21744 | 2.52 | 94.16 |
| 3.20 | 397 | 22141 | 1.72 | 95.88 |
| 3.36 | 308 | 22449 | 1.33 | 97.22 |
| 3.52 | 203 | 22652 | 0.88 | 98.09 |
| 3.68 | 137 | 22789 | 0.59 | 98.69 |
| 3.84 | 98 | 22887 | 0.42 | 99.11 |
| 4.00 | 58 | 22945 | 0.25 | 99.36 |
| 4.16 | 54 | 22999 | 0.23 | 99.60 |
| 4.32 | 32 | 23031 | 0.14 | 99.74 |
| 4.48 | 20 | 23051 | 0.09 | 99.82 |
| 4.64 | 13 | 23064 | 0.06 | 99.88 |
| 4.80 | 14 | 23078 | 0.06 | 99.94 |
| 4.96 | 6 | 23084 | 0.03 | 99.97 |
| 5.12 | 2 | 23086 | 0.01 | 99.97 |
| 5.28 | 2 | 23088 | 0.01 | 99.98 |
| 5.44 | 1 | 23089 | 0.00 | 99.99 |
| 5.60 | 2 | 23091 | 0.01 | 100.00 |

1. A process for continuous mixing of water-absorbing polymeric particles with liquids or other particles while the polymeric particles move in a product stream direction under their own weight, wherein at least a portion of a material undergoing mixing acquires, through a rotational movement of at least one mixing tool secured to a rotating shaft, a momentum opposite the product stream direction.

2. The process according to claim 1 wherein at least two mixing tools are utilized and the mixing tools optionally are situated at different heights along the shaft.

3. The process according to claim 1 wherein the shaft is mounted at one or both of the ends.

4. The process according to claim 1 wherein an extreme tip of the mixing tool has a circumferential speed in the range from 3 to 20 m/s.

5. The process according to claim 1 wherein the product stream direction is less than 45° inclined with regard to the vertical.

6. The process according to claim 1 wherein the angle between the product stream direction and the shaft axis is less than 10°.

7. The process according to claim 1 wherein the pitch angle of the mixing tool is in the range from greater than 0 to 30°.

8. The process according to claim 1 wherein the mixer has a cylindrical wall having a diameter in the range from 90 to 500 mm.

9. The process according to claim 1, wherein a ratio of the diameter of a circumferential path of an extreme tip of the mixing tool to a largest possible diameter of the circumferential path is at least 0.6.

10. The process according to claim 1 wherein a throughput of polymeric particles per m² of cross-sectional area of the mixer in the product stream direction is in the range from 10 to 250 t/h.

11. The process according to claim 1 wherein the polymeric particles are less than 1 mm in diameter.

12. A process for producing water-absorbing polymeric particles, which comprises the polymeric particles being mixed with at least one postcrosslinker, optionally as a solution, according to a process of claim 1.

13. The process according to claim 1, wherein at least a portion of the material undergoing mixing acquires, through the rotational movement of at least one additional mixing tool secured to the rotating shaft, a momentum in the product stream direction.

14. The process according to claim 13 wherein the at least one additional mixing tool through which at least a portion of the material undergoing mixing acquires a momentum in the product stream direction is situated in terms of the product stream direction downstream of the mixing tool through which at least a portion of the material undergoing mixing acquires a momentum opposite the product stream direction.

15. The process according to claim 13 wherein a pitch angle of the additional mixing tool is in the range from less than 0 to −30°.
